(19) United States
(12) Patent Application Publication
(10) Pub. No.: US 2012/0156662 A1
(43) Pub. Date: Jun. 21, 2012

(54) Models for Guiding Physical Work

(75) Inventors: Vijay Mital, Kirkland, WA (US); Darryl E. Rubin, Duvall, WA (US)

(73) Assignee: MICROSOFT CORPORATION, Redmond, WA (US)

(21) Appl. No.: 12/970,902

(22) Filed: Dec. 16, 2010

(51) Int. Cl. G09B 19/00

(52) U.S. Cl. 434/219

(57) ABSTRACT

The subject disclosure is directed towards guiding a user through a physical work task. A model comprising, rules, constraints and equations corresponding to the task generates a work plan based upon user input data and work-related data. The model determines a subtask to perform based upon the data and the current state of the task, and outputs data (plan objects) used to generate of visualization that instructs the user as to how to perform the subtask, e.g., what other part to attach a current component to, what tool is needed, advice, risk assessment, alternatives and so forth. The model may base the current state on a scene input to the model that represents the current state of the task and/or historical data that indicates the current state of the task.

### BACKGROUND

Phones and mobile devices are often equipped with GPS, compasses, range finders, cameras and other sensors. These devices allow users to pinpoint a location, or pinpoint a feature at a location. The pinpoint reference can be used to search a database and retrieve related data, e.g. place names, photographs, a house price, and so forth. The pinpoint reference can also be used to guide a user along a route.

However, there is no current way to use such a mobile device for some common types of user tasks, such as to guide a user in facets of skilled manual work. For example, other than downloading a reference manual or other instructions for use in reading (or possibly playing audio instructions), a computing device is essentially useless with respect to helping a user assemble or disassemble a physical product.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology for guiding a user through a physical work task. A model comprising rules, constraints and/or equations inputs various data to determine a subtask of a work plan corresponding to the physical work task. The work plan may correspond to a scene with at least one feature or object placed on a location or set of locations, and analytics directing this placement.

The input data may include work-related data (such as a list of components), and input user-provided data including data representative of a physical object that is related to that subtask. The input user-provided data may comprise an image, data representative of a recognized image, barcode scan results, RFID read results or a part number, for example.

The input data may include state and/or scene data corresponding to a current state of the work plan. The model may use this data determine the subtask, e.g., where to resume the task.

The model outputs data including presentation data (e.g., plan objects) corresponding to the physical object and the subtask. A presentation mechanism processes the presentation data into a presentation (e.g., a visualization) that guides the user on using that physical object to perform the subtask. The presentation may be played on a mobile device, or a display mechanism (e.g., a television, projector, or computer monitor.)

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components, including a model, for producing a work plan based on various input data.

FIG. 2 is a representation of input data structured to provide a model with information as to how to order the subtasks of a work plan.

FIG. 3 is a flow diagram representing example steps related to selecting a subtask for a user to perform and outputting a visualization as to how to perform the subtask.

FIG. 4 is a representation of a visualization presented to a user that instructs the user with respect to performing part of a work plan.

FIG. 5 is a block diagram representing exemplary non-limiting networked environments in which various embodiments described herein can be implemented.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards providing a user experience that interactively guides the user through a task, based on pre-established rules, constraints and/or equations incorporated into a model or set of models. In general, a user inputs information representing some item or set of items that exists in the physical world into the model, possibly along with other information, and the model outputs a plan that guides the user's work based upon that information and other data to which the model has access. The user may input the information via an image that is recognized as the item, an RFID tag, a barcode, and so forth. The user may tag an object, e.g., by a device pointing action or user gesture, and an object may be identified by a user, spatial coordinate recognition, or recognition by relative positioning (including angle, distance, containment) from another object/feature (e.g., a mountain peak). The guidance may be in the form of a visualization, such as animated graphics and/or a video clip, and/or an augmented reality.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and information processing information in general.

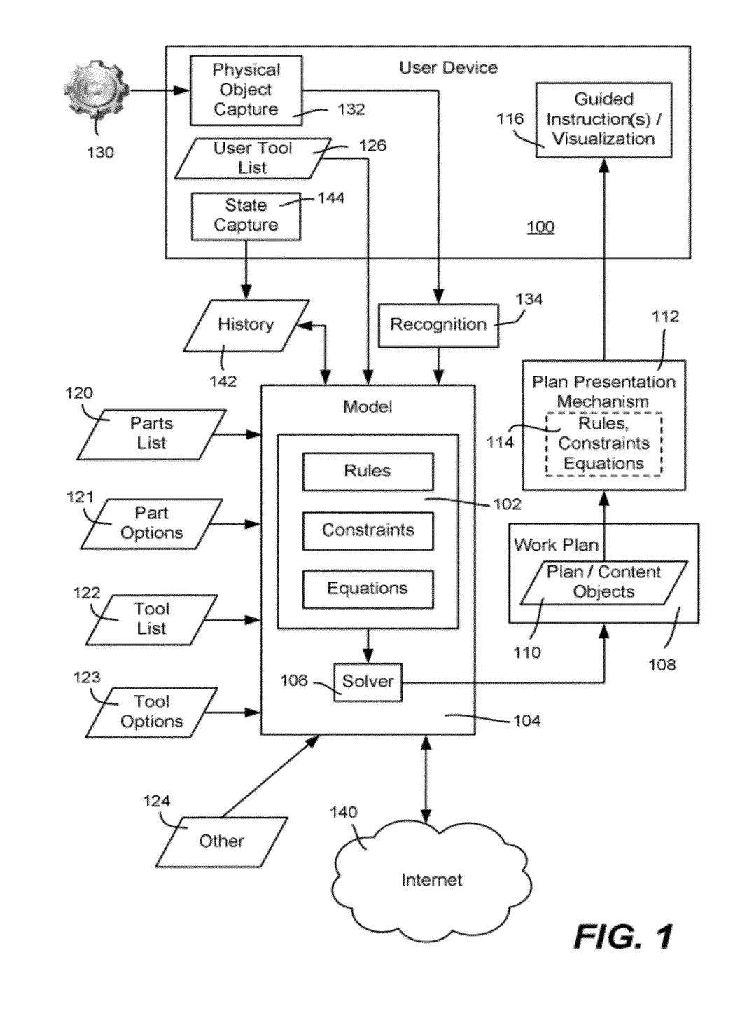

FIG. 1 shows example components for guiding a user via a device 100 through a physical work task according to the rules, constraints and/or equations (block 102) of a model 104. The device 100 may be a mobile device, such as a mobile phone, or alternatively may be a computer system, gaming console coupled to a display, and so forth.

The model 104 may be accessed via a cloud service or the like, and/or may be downloaded in whole or in part to the device 100. There may be many models from which a user may select. For example, one user may select a model to assemble or repair a motorbike, while other users may select models to do a landscaping project, put together an elaborate meal, or even a model that gives a user ideas (e.g., given a set of items such as planks of wood, what can the user make?).

A model such as the model 104 may be developed by an entity having an interest in guiding a user's work, such as a company that sells products to be assembled, do-it-yourself projects, or aftermarket replacement parts. An engineer or team may create a model (and/or associated work-related input data as described below), for use by technicians, mechanics and/or apprentices to follow. Other models may be generated by internet contributors, such as described in U.S. patent application Ser. No. 12/958,668, entitled “Addition of Plan-Generation Models and Expertise by Crowd Contributors,” hereby incorporated by reference.

In general, given various input data (examples of which are described below), the data are processed by a solver 106 (which may comprise multiple constituent solvers) based upon the rules, constraints and/or equations (block 102) to provide a solution, which in one embodiment is in the form of a work plan 108, e.g., comprising a scene with features/objects placed on a location/set of locations, and the analytics directing this placement. The scene may comprise geometrical and spatial representations of relevant locations, and features or objects to be assembled, or placed, or visited, or moved in the locations. In addition to generating the relevant plan 108, the model 104 may include rules, constraints and/or equations directed towards generating or providing other the user with other useful devices such as a schedule, a running budget, and so forth.

The term “rules” as used herein generally refers to conditional statements, such that if one or more conditions of a rule are satisfied, then one or more actions are to be taken. For example, a rule may be expressed along the lines of “if subassembly A is completed and subassembly B is completed, then connect subassembly A to subassembly B.” The completion states of subassemblies A and B are one type of input data, as described below. The term “constraint” as used herein means that a restriction exists with respect to the input data or some combination of the input data, for example. For example, “air pressure needs to be at least 60 psi” is a constraint. Equations generally express mathematical relationships. Additional details regarding models, plans, rules, constraints and/or equations and solvers are described in U.S. patent application Ser. No. 12/752,961, entitled “Adaptive Distribution of the Processing of Highly Interactive Applications,” hereby incorporated by reference.

In one implementation, the output from the model 104 may be in the form of plan objects 110 of the work plan 108 that are used in by a plan presentation mechanism 112 (e.g., a content synthesizer) for synthesizing or guiding a presentation such as guided instructions/a visualization 114 (possibly including audio; a presentation also may be in the formal of audio-only instructions). The model 104 may specify presentation-related rules, constraints and equations (block 116) as to how the content is to be synthesized or presented. Alternatively, or in addition to the model 104, the user and/or another source may specify such presentation-related rules, constraints and equations.

For example, according to presentation-related rules, constraints and/or equations a product may have animated graphics, a slideshow and/or video generated that show an assembly process from start to finish. Generating such a visualization from a model is described in U.S. patent application Ser. Nos. 12/965,857 and 12/965,861 entitled “Synthesis of a Linear Narrative from Search Content” and “Using Cinematographic Techniques for Conveying and Interacting with Plan Sagas,”respectively, hereby incorporated by reference.

The various input data includes a combination of work-related data and user-provided data. For example, consider a user assembling or repairing a motorbike. The work-related data may include component concepts like a parts list 120 of all components of the motorbike, part options 121 (e.g., acceptable substitutes for some of the parts), a tool list 122 as to what tools are needed for the task, and tool options 123 (e.g., an adjustable wrench instead of a ⅜″ crescent wrench specified in the tool list may be used).

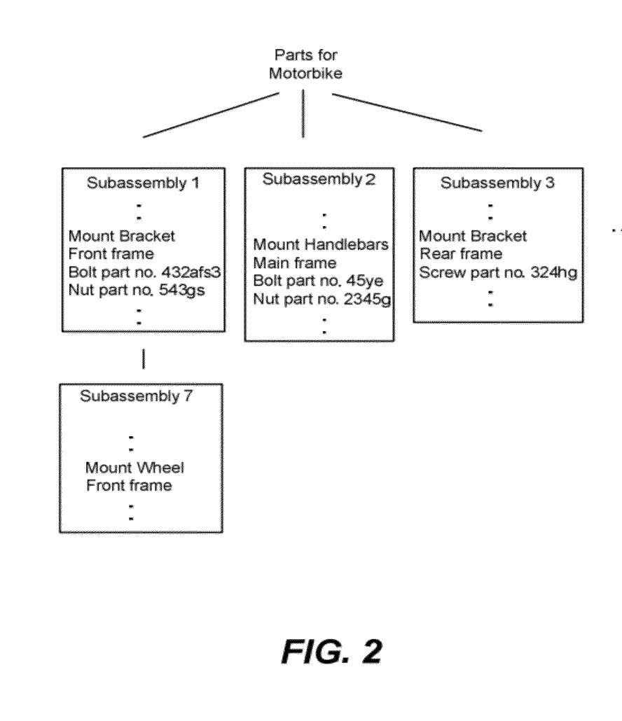

The work-related data may be arranged in any way that the model can understand, but in one implementation corresponds to a hierarchical tree or other graph corresponding to an ordered list of items. The order may be used to provide the model with information as to how to proceed, such as corresponding to an assembly order, as generally represented in FIG. 2. Peer levels in the data may be used to indicate which sub-tasks may be performed independently. Having the structure of the data provide the model with such information allows the same model to be used for different guidance that depends on the data, e.g., a model that guides users in assembling kitchen cabinets may be used for one style of kitchen cabinets with doors that have handles as well as for styles that do not.

The work-related data may be provided by the same entity that provides the model, or a different entity. For example, a model (or set of models) may be provided that guides a user through cooking an elaborate meal, but the parts/components list (of ingredients in this work plan) may be provided by different companies who each wants its brands of products to be listed (e.g., company X's flour). Another model may guide furniture movers in placing parts (furniture) in the rooms of a house.

Other information 124 may be may be input to the model, e.g., GPS data, dates, times, ambient light, ambient noise, and so on. Still other information includes user provided data, which in the example of FIG. 1 includes a user tool list 126 setting forth the tools that the user has at his or her disposal. This may be matched by the model 104 against the tool list 122 of the tools that are needed.

As the user works through the task, the user may provide physical object data, corresponding to a physical object 130 (or set of objects) to the model 104 in an appropriate way. One way for the user to do this is to capture (block 132) a representation of that physical object 130, such as image of the object or a barcode attached to the object. The user may also provide the results of a barcode scan or RFID read as the captured representation of the object 130. If is also feasible for the user to type text and/or speak about the object 130 in some way that identifies the object (“reducing gear”) however relying on the user is likely more subject to errors or ambiguity. A recognition mechanism 134 may be used to convert the data about the object (e.g., an image of the object or the object's barcode) to an actual part number or the like, e.g., via machine image or barcode recognition.

Continuing with the motorbike example, if the user picks up a part (e.g., a bolt), identifies that part in some appropriate way as described above, the model 104 is now able to locate the rules, constraints and/or equations associated with that part. For example, the model 104 may include one or more rules, constraints and/or equations directed to checking that the physical object 130 is the correct one given the current state of the task. By way of an example, the user may hold up the bolt, have its image captured, and sent for recognition (possibly along with some information such as zoom magnification or a distance scale so that the actual size is known to the model). The model 104 may then respond with appropriate audio and/or video output, such as to represent “no, that is not the correct one” or “yes, now slide the threaded end through the opening . . . ” and so on. Another rule may be a placement-related rule, such as specifying where the part is placed (e.g., bolted to the main frame).

Another simple rule may be directed towards cross-checking the tool or tools associated with that part (in the lists 122 and/or 123) against the user tool list 126, and notifying the user which tool is needed. If the user does not have the right tool or set of tools, the model may suggest working on a separate portion of the task until the tool is acquired. The model 104 may also be tied in with advertising and/or online stores to advertise or facilitate purchase of a needed tool.

The model 104 may access the internet 140 as needed to solve for the data, subject to the rules, constraints and/or equations, such as to acquire more data. For example, a user may send barcode data to the model that does not match known barcode data on the parts list 120 or part options 121. However, the model 104 may be configured with a rule that allows the barcode to be checked with a web service or the like that keeps an updated list of new items that become available, whereby the model finds out that the barcode refers to an acceptable matching part, and proceeds from there. The model may also have a rule that updates the parts list 120 and/or options 121 as such new information is obtained.

In addition to user-provided data, the model may maintain history data 142, indicative of the state of the task, for example. In this way, the model 104 can solve a problem (e.g., what to do next) based on what has been done before. The user device may also capture the state (block 144) for use as part of the history data 142. By way of example, consider a user who starts a project without guidance, gets the project to a certain state, and then seeks guidance via the model 104. The model 104 may be able to solve the problem of what to do next given accurate data (e.g., a machine recognized image) as to the current state/scene of the task, even though no prior history had been accumulated through the model's guidance. The model (or a process coupled thereto) may synthesize snapshot contexts obtained by the mobile device (for example) into a larger scene/current larger state. The subsequent solution may be a next step forward, whereby the model's output data may advance the presentation to begin at the point (state/scene) where the user currently is. The solution may be a step backward (of possibly many steps), e.g., remove the handlebars from the frame because there is a coil spring that needs to be put on first.

For a work plan, the model may thus specify tools or suggest alternative parts or tools, and instruct the user how to use them. In addition to these output data, a model may output sequences, other alternatives (e.g., actions that may be taken), suggestions, recommendations, implications, warnings, dependencies, procedures, risks and the like.

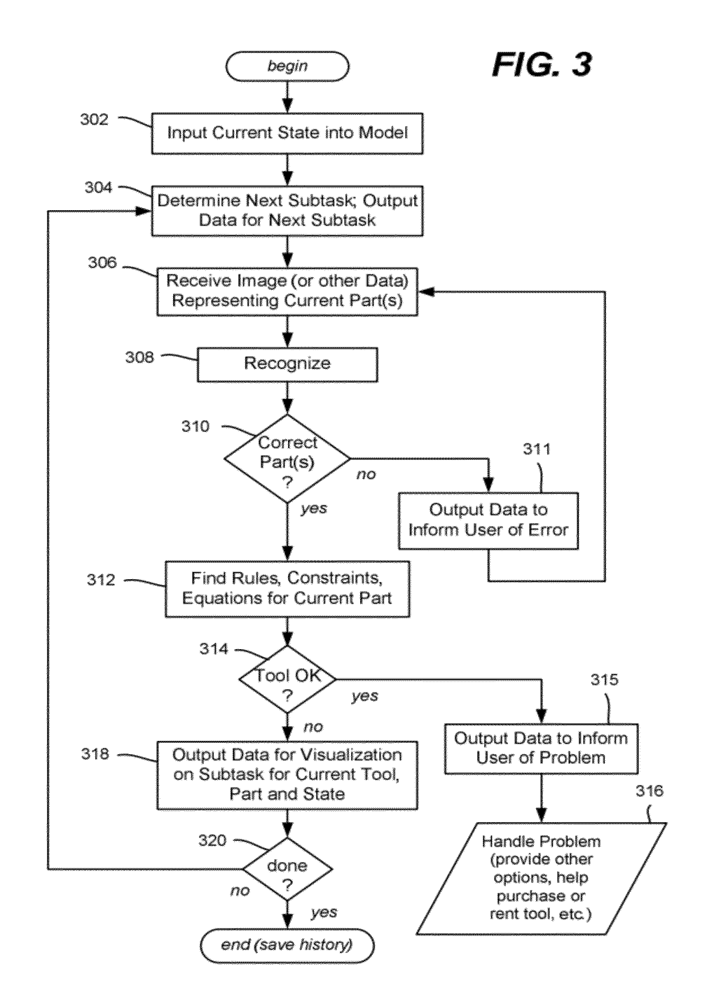

FIG. 3 is a flow diagram showing example steps of a model for a simple assembly task. Step 302 represents inputting the current state of the model, (and any other needed initialization data such as what tools the user currently has). Step 304 represents determining what subtask to do next given the current state, according to the rules, constraints and/or equations. In this example, the next task corresponds to selecting a part to use, and thus the output data corresponds to an appropriate instruction that is conveyed to the user.

Step 306 represents receiving a user-provided representation of the part (e.g., image/barcode image, barcode scan result, RFID read result and so on) to the model. This representation may need to be further recognized and/or converted, as represented by step 308, such as to convert an image into a numerical form (a part number), for example. Note that the model may communicate with an external service or the like to have the recognition/conversion performed. Further note that the subtask may correspond to more than one part, e.g., select a bracket, then select a screw for that bracket, and so on, and thus steps 306 and 308 may be repeated as necessary to obtain a collection of parts.

The recognized part (e.g., its part number) or part collection is evaluated at step 310 against the part or part collection that the user was asked to select at step 304. If not correct, step 311 outputs data to inform the user of the problem (e.g., an incorrect part was chosen) and to try again.

If the part is the correct one, step 312 represents finding the next rules, constraints and/or equations for the part (if not already found following step 304's determination of a need for that part). One of the rules, represented by step 314, may be to check whether the user currently possesses the appropriate tool or tools for that part. Note that such a check in general may not be done for an entire task, because the user may have different tools available at different times while the task is being worked through. Also, the user may provide a data representation of the tool (e.g., an image) if the user is not sure as to which is the correct tool, however such tool-recognition steps are not shown in FIG. 3 for purposes of simplicity.

If the user does not have what is needed, data is output (step 315) by the model to inform the user of the problem, and the problem handled from there as appropriate (step 316), e.g., wait for the user to get the tool, help the user obtain the tool, offer the user a different (e.g., peer) subtask to work on instead, and so on.

Step 318 represents the typical course of action, where the user has selected the correct part or part collection, and has the correct tool. In this situation, the model outputs plan objects or the like that are used to generate a presentation (visualization) of the subtask. For example, the visualization may show a video clip or slideshow of an expert using the tool to attach a selected bracket (one part of a collection) via a screw (another part of the collection) to a certain location on another physical item (which may be another part of the collection or based upon the state data, e.g., the motorbike frame in its current state of assembly).

Step 320 repeats the process until the user is done, whether for the moment or because the entire task is complete. The state may be saved as history data for resuming the task, or as a task complete state. When complete, information about the task may be uploaded as feedback or the like to the provider of the model, e.g., how long it took, how long each subtask took, how many times the user repeated a visualization, and so forth, such as for use in improving the model and/or work-related data.

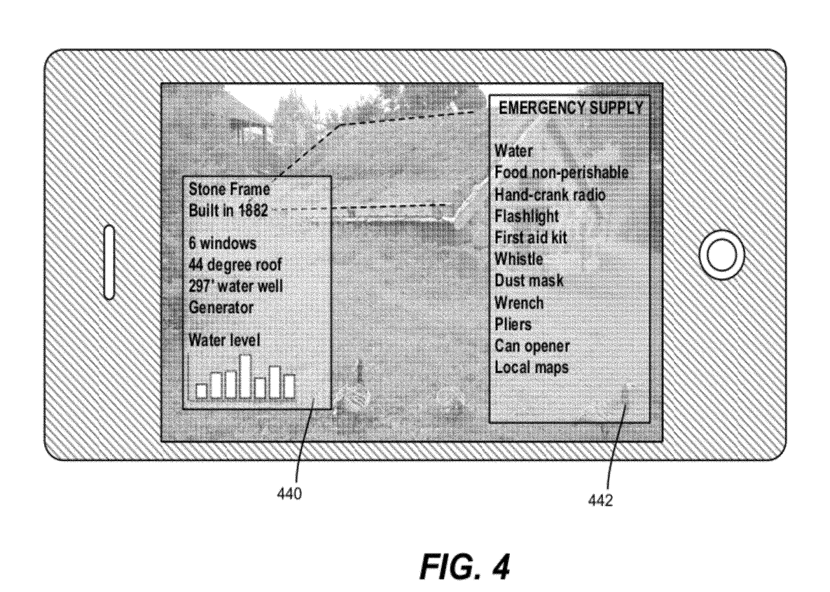

While the above examples were mostly directed to an assembly work task, any physical object-related task may be modeled, including disassembly, construction, modification or destruction of artifacts, placement of items, collecting items, and so forth. FIG. 4 shows a visualization of a structure, such as looked up by GPS coordinates provided by a mobile device. Data 440 related to the structure may be superimposed above an image of the structure. The data may be collected from a database, and/or computed from an image of the structure (e.g., the roof angle computed from the dashed lines in the image. A work plan, such as to gather various items for keeping in the structure, may have elements displayed to the user, e.g., one set of items are emergency-related items displayed to the user in an overlay 442 as part of the visualization.

Further, while the above description is applicable to a mobile device, it is understood that any device with the appropriate input mechanisms (e.g., camera) and output mechanisms (display and/or speakers) may be used. For example, a user with Microsoft's Kinect™ technology coupled to an Xbox® device which in turn is coupled to a television may assemble the motorbike based upon the visualization rendered through the television. The Kinect™ device may feed images and/or video to the Xbox® device, which accesses a cloud service and/or its own storage to process the data via the chosen model. The model solves for the input data, and produces the guided visualization rendered via the Xbox® device to the television. A large television or a projector may be used for larger groups of people, such as for hands-on training or an interactive teaching experience in which the trainees/students work with real physical items.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

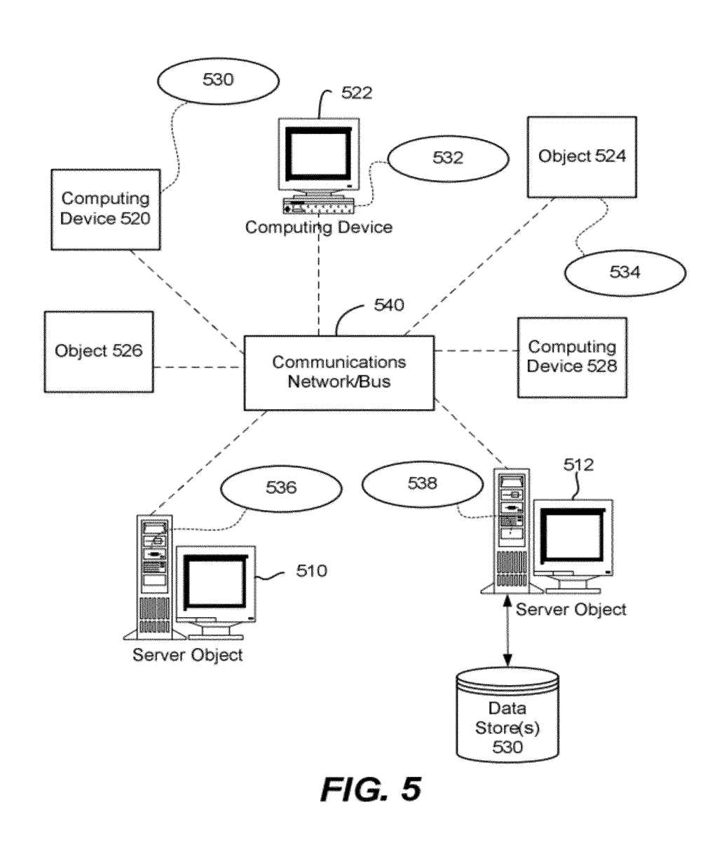

FIG. 5 provides a schematic diagram of an exemplary networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Exemplary Computing Device

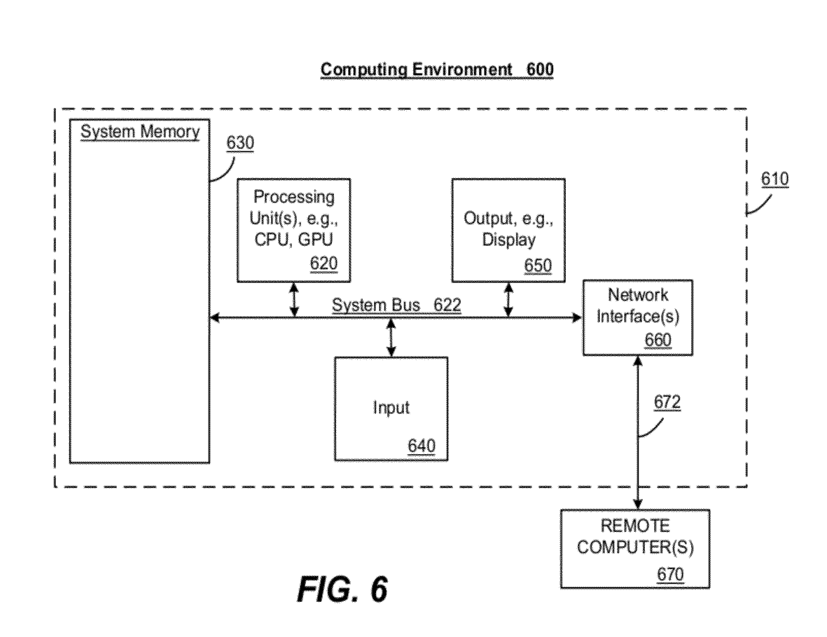

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a system, comprising:
a model comprising rules, constraints or equations, or any combination of rules, constraints or equations, the model configured to determine a subtask of a work plan based upon work-related data, to input user-provided data including data representative of a physical object that is related to that subtask, and to output data including presentation data corresponding to the physical object and the subtask; and
and a presentation mechanism configured to process the presentation data into a presentation of at least part of the work plan that guides a user on using that physical object to perform the subtask.

2. The system of claim 1 wherein the presentation data comprises plan objects.

3. The system of claim 1 wherein the presentation mechanism comprises a content synthesizer.

4. The system of claim 1 wherein the work plan corresponds to a scene with at least one feature or object placed on a location or set of locations, and analytics directing this placement.

5. The system of claim 1 wherein the model is further configured to input state or scene data, or both state and scene data corresponding to a current state of the work plan, and to determine the subtask based on the data to guide the user in completing at least one remaining part of the work plan.

6. The system of claim 1 wherein the work-related data comprises a list of components.

7. The system of claim 1 wherein the list of components is structured based upon an order in which the components are used to complete the work plan.

8. The system of claim 1 wherein the work-related data comprises a list of tools.

9. The system of claim 1 wherein the input user-provided data identifies one or more user tools.

10. The system of claim 1 wherein the input user-provided data comprises an image, data representative of a recognized image, barcode scan results, RFID read results or a part number.

11. The system of claim 1 wherein the model is configured to output data corresponding to one or more sequences, one or more alternatives, one or more suggestions, one or more recommendations, one or more implications, one or more warnings, one or more dependencies, one or more procedures, or one or more risks, or any combination of data corresponding to one or more sequences, one or more alternatives, one or more suggestions, one or more recommendations, one or more implications, one or more warnings, one or more dependencies, one or more procedures, or one or more risks.

12. The system of claim 1 wherein the user-provided data is communicated from a mobile device, and wherein the presentation mechanism outputs a visualization to the mobile device.

13. The system of claim 1 wherein the user-provided data is communicated from a camera coupled to a game console or computer, and wherein the presentation mechanism outputs a visualization to a display mechanism coupled to the game console or computer.

14. In a computing environment, a method performed at least in part on at least one processor, comprising:
inputting work-related data into a model comprising rules, constraints or equations, or any combination of rules, constraints or equations;
inputting state data corresponding to a state of a work plan into the model;
inputting user-provided data including data representative of a physical object into the model;
processing the work-related data, the state data and the user-provided to determine a subtask of a work plan; and
outputting data for presenting a visualization to a user that guides the user in using that physical object to perform the subtask.

15. The method of claim 14 wherein processing the state data comprises recognizing a completion state of the work plan and determining the subtask relative to the completion state.

16. The method of claim 14 wherein inputting the work-related data comprises inputting a structured list of components, in which the structure corresponds to an order of subtasks.

17. The method of claim 14 further comprising, evaluating whether the data representative of the physical object corresponds to the subtask.

18. One or more computer-readable media having computer-executable instructions, which when executed perform steps, comprising:
determining a subtask corresponding to a work plan;
receiving data representing a component associated with the work plan;
determining that the component is correct for the subtask;
locating one or more rules, constraints or equations, or any combination of one or more rules, constraints or equations, associated with that subtask; and
using the one or more rules, constraints or equations, or any combination of one or more rules, constraints or equations, to output plan objects from which a visualization of using the component part in performing the subtask is generated.

19. The one or more computer-readable media of claim 18 having further computer-executable instructions comprising inputting a current state into the model, and wherein determining the subtask comprises determining the subtask relative to the current state.

20. The one or more computer-readable media of claim 18 wherein the component corresponds to a part that is associated with a tool, and having further computer-executable instructions comprising, determining from user-provided data whether the user has a tool for performing the subtask.
